(19) United States
(12) Patent Application Publication
(10) Pub. No.: US 2005/0072927 A1
(43) Pub. Date: Apr. 7, 2005

(54) Gas concentration measuring device and method

(76) Inventor: Shen-Kwan Chiang, Taipei Hsien (TW)

Correspondence Address: SAWYER LAW GROUP LLP, P O BOX 51418, PALO ALTO, CA, 94303, US

(21) Appl. No.: 10/926,198

(22) Filed: Aug. 24, 2004

(30) Foreign Application Priority Data
Oct. 6, 2003 (TW) 092127633

(51) Int. Cl. G01N 21/00

(52) U.S. Cl. 250/338.5

(57) ABSTRACT

A gas concentration measuring device and a gas concentration measuring method are provided. The gas concentration measuring device includes an IR gas measuring module, a circuit processing module, and a display module. In the gas concentration measuring method, the IR gas measuring module measures concentration of a gas and outputs a concentration signal corresponding to the measured gas concentration. The circuit processing module receives the concentration signal and processes the concentration signal to obtain an electrical signal in linear proportion to the gas concentration. The display module receives the electrical signal and displays the gas concentration corresponding to the electrical signal.

### FIELD OF THE INVENTION

The invention relates to devices and methods of measuring gas concentration, and more particularly, to a gas concentration measuring device and method with improved measuring precision and sensitivity.

### BACKGROUND OF THE INVENTION

According to research by the America Society of Heating, Refrigeration and Air Conditioning Engineers (ASHRAE), it indicates that indoor air should be refreshed when the gas concentration of carbon dioxide reaches about 1,000 ppm. Statistically, more than 90% of buildings usually have the gas concentration of carbon dioxide exceeding this critical value. Since carbon dioxide is produced by human breath, when people stay in a closed space for a long time and inhale too much carbon dioxide, it would cause the brain to function slowly and make people feel dizzy and sleepy. Therefore, a gas sensor such as a carbon dioxide sensor is usually used to measure the gas concentration of carbon dioxide.

Such gas sensor is widely used in, for example, air conditioning, safety detection, agricultural production, and military applications such as submarine air-quality control and gas absorption device performance determination, as well as waste-water analysis to monitor the level of organic carbon. However, currently, the domestic air monitoring and sensing devices are mostly imported from foreign countries, and such imported devices have high retail prices, making the cost for purchasing the devices increased for users. Prior arts related to the gas sensor include U.S. Pat. No. 5,464,369 and U.S. Pat. No. 5,775,406.

U.S. Pat. No. 5,464,369 discloses a method and apparatus for controlling the environment within an enclosed space. The apparatus monitors environmental variables, and estimates the rate at which a gas is being generated within the enclosed space. Based on the estimated gas generation rate, the apparatus may be configured to control a Heating, Ventilating, and Air-conditioning System (HVAC) system. U.S. Pat. No. 5,775,406 discloses a ventilation message display system and method for a vehicle usage. The system includes a carbon dioxide sensor to generate messages alerting the driver based on the amount of carbon dioxide, and allows the driver/user to input control commands.

The aforementioned apparatus disclosed in U.S. Pat. No. 5,464,369 is used in large air conditioning devices, but is not suitable for use in domestic or personal products due to its large and complicated structure and price. The system disclosed in U.S. Pat. No. 5,775,406 has to be controlled manually not automatically, making it less convenient. For both references, the carbon dioxide sensing component cannot be separated from the apparatus or the system, limiting the applicability of the apparatus or the system.

U.S. Pat. No. 6,114,700 discloses a non-dispersive infrared (NDIR) instrument used for measuring infrared absorptivity by gas sampling and its measuring method. The NDIR instrument includes a light source having different temperature coefficient disposed at one end of a sample cell to increase the channel temperature, and a NDIR sensor disposed at the other end of the cell to monitor the concentration of carbon dioxide. Another monitoring device is provided in a servo loop to control continuous light output to optically measure the concentration of carbon dioxide. Gases are analyzed by the NDIR sensor, and automatically checked and displayed after temperature compensation and signal conversion.

However, the above NDIR method does not utilize a non-linear compensation circuit and thus has significant error when used in high-concentration and low concentration gas measurement. Therefore, the NDIR method is only applicable to draining channels. Also, samples in the analyzing apparatus tend to be interfered by moisture, and thus a moisture remover is required to remove such interference. Furthermore, a converting device has to work at a high conversion ratio and needs frequent maintenance or cleaning. This method needs to operate with auxiliary equipment and is only used in determining specific concentration of gases due to conversion limitation.

U.S. Pat. No. 6,494,777 discloses a carbon dioxide concentration modulation device. The modulation device includes an IR sensor to measure the concentration of carbon dioxide in the air, so that an air regulating control module can determine whether the carbon dioxide concentration in an enclosed space, reaches an upper limit. If yes, then fresh air is charged into the enclosed space from outside by an air regulating mechanism to reduce the concentration of carbon dioxide. Using the characteristic that gas molecules absorb infrared light of a specific wavelength, the gas concentration is determined by comparing the IR absorption chart with a standard chart. Gas concentration relationship follows Beer's Law. Therefore, the concentration of carbon dioxide in the gas to be measured is obtained by calculating the absorption intensity of the spectrum, according to the relationship between absorption intensity of carbon dioxide molecules and concentration.

However, since the relationship between the absorption intensity and concentration of gas molecules are not linearly related, the measurement precision cannot be improved. Furthermore, Beer's Law works only at low gas concentrations for qualitative and quantitative analysis. If this method is applied to measure highly concentrated gases, the measuring precision and sensitivity are even lower. At the same time, Beer's Law is only effective for absorption occurred in a specific range of concentration of substance (gas molecule). Once the gas concentration changes greatly and the gas molecules are subjected to phenomenon such as dissociation and polymerization, the gas concentrations can no longer be measured accurately.

For both highly concentrated and lowly concentrated gas molecules, the above methods cannot provide high-precision and high-sensitivity gas concentration measurement. Therefore, there is a need for a high-precision and high-sensitivity gas measuring method and device.

### SUMMARY OF THE INVENTION

It is therefore an objective of the invention to provide a gas concentration measuring device and a method for measuring the gas concentration with improved measuring precision and sensitivity.

It is another objective of the invention to provide a gas concentration measuring device and a method for measuring the gas concentration, which can be used alone.

In order to achieve the above and other objectives, the gas concentration measuring device includes an IR gas measuring module, a circuit processing module, and a display module. The IR gas measuring device measures a concentration of a gas to be measured in the air and transmits a corresponding concentration signal. The IR gas measuring module includes a controller, a clock generator, an IR sensor, and an IR light source. The controller simultaneously provides signals to the clock generator and the IR sensor. The clock generator generates a square-wave signal that drives the IR light source.

The circuit processing module receives the concentration signal and converts the concentration signal into a processed electrical signal. The circuit processing module comprises at least one amplifier circuit, a linearly correcting device, a filter, and a peak sampler. The linearly correcting device corrects the electrical signal to generate a linearly corrected electrical signal linearly proportional to the gas concentration. The display module receives the linearly corrected electrical signal and displays the gas concentration corresponding to the linearly corrected electrical signal.

The method of measuring gas concentration utilizing the above gas concentration measuring device comprises the following steps: measuring the gas and outputting a concentration signal corresponding to the measured gas concentration by an IR gas measuring module; then receiving the concentration signal and processing the concentration signal to obtain an electrical signal in linear proportion to the concentration of the gas by a circuit processing module, and receiving the electrical signal and displaying a gas concentration corresponding to the electrical signal by a display module.

In the step of measuring the concentration of the gas, a controller of the IR gas measuring module simultaneously provides a signal to a clock generator and an IR sensor, the signal triggers the clock generator to drive an IR light source, so that the IR light source, after focusing, emits light beams in parallel to the IR sensor, thus the IR intensity at a specific wavelength can be sensed and the gas concentration from the IR intensity calculated. In the step of calculating the gas concentration, the controller simultaneously controls the clock generator and the IR sensor receiving the remaining amount of light after absorption by the gas.

In the step of processing the concentration signal, the concentration signal is amplified and filtered for noise. Then, sampling and calculation according to Beer's Law are sequentially performed to obtain an electrical signal corresponding to the gas concentration. Then, the electrical signal is linearly corrected. The uncorrected electrical signal and the gas concentration are in an exponential relationship, and the linearly corrected electrical signal and the gas concentration are in proportion (i.e. linear relationship).

The gas concentration measuring device of the invention can work with a physical circuit or a signal processing device to correct the non-linear response resulting from the IR absorption of the gas to obtain a linear response. Thus, a gas concentration measuring device with improved measuring precision and sensitivity and a method for performing the same are provided. Furthermore, the gas concentration measuring device and the method can be used alone, rendering the applicability thereof much broader.

### BRIEF DESCRIPTION OF THE DRAWINGS

The present invention can be more fully understood by reading the following detailed description of the preferred embodiments, with reference made to the accompanying drawings, wherein:

FIG. 1 is a schematic view of a gas concentration measuring device according to a preferred embodiment of the invention;

FIG. 2 is a schematic view of an IR gas measuring module of a gas concentration measuring device according to the preferred embodiment of the invention;

FIG. 3 is a schematic view of a circuit processing module of a gas concentration measuring device according to the preferred embodiment of the invention;

FIG. 4A is a graph of a relationship between a gas concentration and an output voltage before linear correction according to the invention;

FIG. 4B is a graph of a relationship between a gas concentration and an output voltage after linear correction according to the invention; and

FIG. 5 is a flow chart of a method for measuring a concentration of a gas according to a preferred embodiment of the invention.

### DETAILED DESCRIPTION OF THE PREFERRED EMBODIMENTS

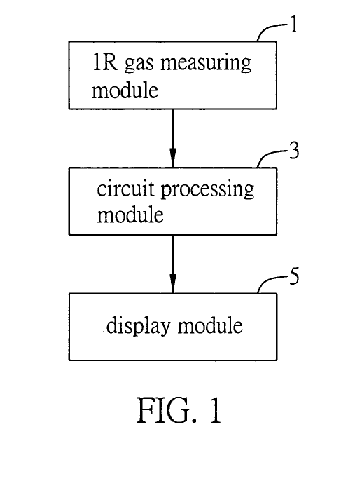

Referring to FIG. 1, the gas concentration measuring device of the invention includes an infrared (IR) gas measuring module 1, a circuit processing module 3, and a display module 5. The gas concentration measuring device can be either used alone, or in combination with an air conditioner. The gas concentration measuring device can be installed inside the air conditioner. For simplicity, the air conditioner, which is well known, is not shown in the drawings.

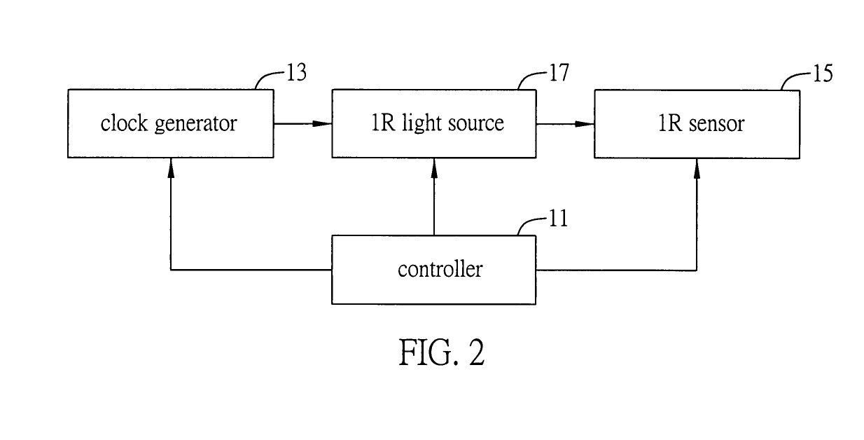

The IR gas measuring module 1 is used to determine the concentrations of gases in the air to be measured, and transmit corresponding concentration signals. Referring to FIG. 2, the IR gas measuring module 1 includes a controller 11, a clock generator 13, an IR sensor 15 and an IR light source 17.

The controller 11 simultaneously provides signals to the clock generator 13 and the IR sensor 15. The controller 11 can be, for example, an IR light source controller. The synchronous signals trigger the clock generator 13 to generate a square wave signal which drives the IR light source 17 to emit IR light to the IR sensor 15, where the IR sensor 15 is provided opposite to the IR light source 17. The controller 11 simultaneously controls the clock generator 13 and the IR sensor 15, which receives the remaining amount of the light from the IR light source that has not been absorbed by the gases (e.g. carbon dioxide) to be measured. The concentration of carbon dioxide is thereby calculated. The gas measuring module 1 outputs a corresponding concentration signal according to the obtained gas concentration. The concentration signal is a low-voltage signal. Although according to the present invention, carbon dioxide is cited as an example of the gas measured, other applicable gases such as carbon monoxide, hydrocarbon, and the like can be also measured.

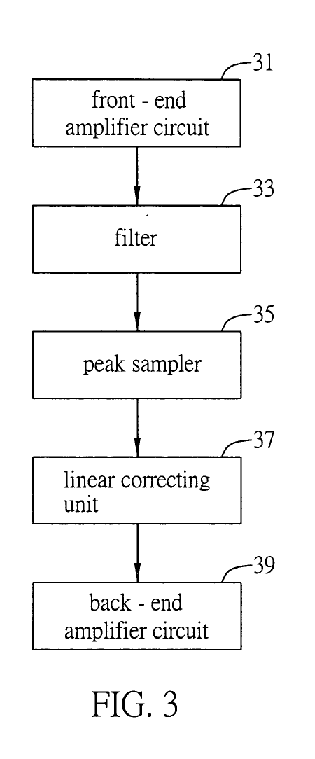

The circuit processing module 3 is used to receive and process the concentration signal to generate a linearly corrected electrical signal in proportion to the concentration of the gas to be measured. Referring to FIG. 3, the circuit processing module 3 includes a front-end amplifier circuit 31, a filter 33, a peak sampler 35, a linear correcting unit 37 (e.g. a linear correcting circuit) and a back-end amplifier circuit 39. The front-end amplifier circuit 31 and the back-end amplifier circuit 39 are used to amplify a small-voltage concentration signal. The filter 33 is used to filter noise. The peak sampler 35 picks out the required signal. The linear correcting unit 37 is used to correct the concentration signal to be a linear signal that is in proportion (i.e. linear relationship) to the concentration of the gas to be measured. Thereby, the precision and sensitivity of measuring the gases are increased.

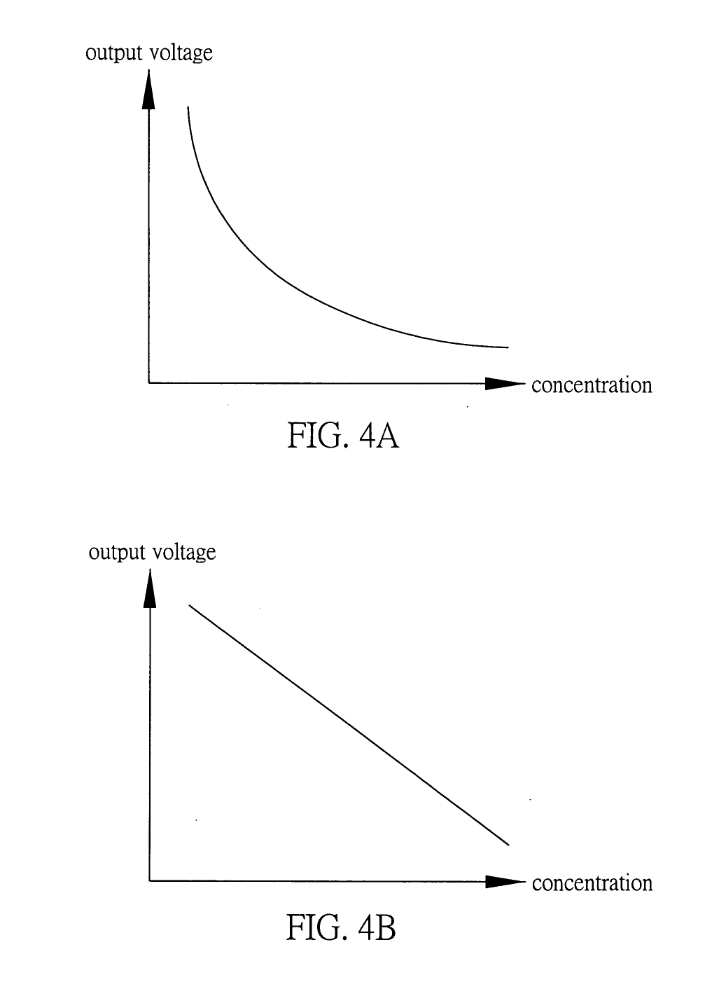

When the circuit processing module 3 receives the concentration signal from the IR gas measuring module 1, the concentration signal, which is a small-voltage signal not easily detected, is amplified by the front-end amplifier circuit 31 for signal recognition. The amplified signal contains noise that need to be filtered out via the filter 33 to increase the precision of signal recognition. Then, the peak sampler 35 performs sampling and calculating according to Beer's Law to obtain the electrical signal (output voltage) of uncorrected gas concentration, as shown in FIG. 4A.

According to Beer's Law, at a specific wavelength, the light absorption and the concentration of light absorbing material are in an exponential relationship. Using the exponential relationship between the gas molecule absorption intensity and the gas concentration, the concentration of the gas to be measured is obtained by calculating the absorption intensity in the spectrum. Beer' Law which shows the relationship between the light absorption and the gas concentration, is well known in the art and thus omitted here.

The linear correcting unit 37 is used to correct the electrical signal associated with the gas to be measured. FIG. 4B is a graph of a relationship between a concentration of a gas to be measured and an electrical signal (output voltage) after linear correction. The linearly corrected electrical signal is in proportion to the gas concentration. The linearly corrected electrical signal is transmitted after amplification by the back-end amplifier circuit 39. In this embodiment, the circuit processing module 3 has two amplifier circuits, i.e., the front-end amplifier circuit 31 and the back-end amplifier circuit 39. It is noted that the circuit processing module 3 can be optionally provided with only the front-end amplifier circuit 31 for signal recognition.

The display module 5 is used to receive the linearly corrected electrical signal and display the gas concentration corresponding to the electrical signal. The display module 5 is optionally provided with an amplifier circuit for amplifying the linearly corrected electrical signal. The display module 5 includes at least a display device for image displaying and a driver circuit unit (not shown) which receives the linearly corrected electrical signal and drives the display device. The display device and the driver circuit unit are well known in the art and thus omitted here.

The method of measuring gas concentrations is described in detail as follows.

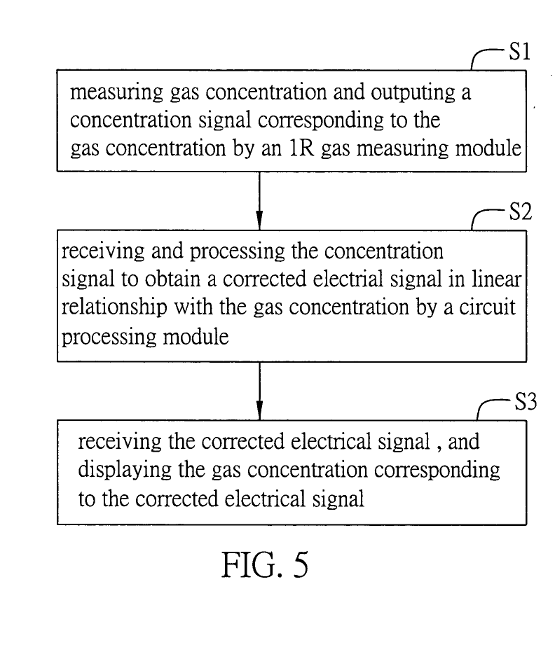

Referring to FIG. 5, when the gas concentration measuring device of the invention is actuated, the IR gas measuring module 1 measures the gas (Step S1). The gas can be, for example, carbon dioxide, carbon monoxide, and hydrocarbon.

At Step S1, the controller 11 of the IR gas measuring module 1 provides synchronous signal to the clock generator 13 and the IR sensor 15, and triggers the clock generator 13 to drive the IR light source 17. The IR light source 17 emits light to the IR sensor 15 which locates opposite to the IR light source 17, thus the intensity of IR light at a specific wavelength can be measured and gas concentration can be calculated. The specific wavelength is chosen according to the IR-absorbing characteristics of the molecules of the gas (e.g. carbon dioxide, carbon monoxide, hydrocarbon, and the like) to be measured.

As such, the IR gas measuring module 1 outputs a concentration signal according to the concentration of the gas to be measured. The concentration signal is a small-voltage signal.

At Step S2, the circuit processing module 3 receives the concentration signal from the IR gas measuring module 1 and processes this concentration signal to obtain an electrical signal linear to the gas concentration. More specifically, the concentration signal is amplified and filtered to increase the precision of signal recognition. Then, sampling and calculation according to Beer's Law are performed to obtain the uncorrected electrical signal corresponding to the concentration of the gas to be measured. The uncorrected electrical signal and the gas concentration are in an exponential relationship, as shown in FIG. 4A. Then, the linear correcting unit 37 linearly corrects the uncorrected electrical signal to obtain the corrected electrical signal. Now, the corrected electrical signal is linearly proportional to the gas concentration, as shown in FIG. 4B. The corrected electrical signal is then amplified before proceeding to S3.

At Step S3, the display module 5 receives the corrected electrical signal and displays the gas concentration corresponding to the corrected electrical signal.

Since the gas measuring device and method of the invention corrects the non-linearity response of gas absorbing the IR light source, problems caused by non-linear relationship between the gas molecule absorption intensity and gas concentration can be eliminated. Thereby, the precision and sensitivity of measuring gas of both high and low concentrations are significantly increased. Therefore, the user monitors the gas concentration via the display device 5 with increased measuring precision and sensitivity.

The gas measuring device of the invention can be used alone, which is in contrast to the prior art that the CO₂ measuring device is a part of a larger system. The gas measuring device of the invention can be individually mounted in a place regardless whether there is any air conditioner. The gas measuring device of the invention can also be either integrally mounted or mounted in the form of a module into a small air conditioner (such as windrow type or separate type indoor air conditioner), a car air conditioner, large air conditioning equipment (such as industrial air conducting equipment), or specialized air conditioning equipment. The gas-measuring device can be also modularized to mount on the above air conditioner. The gas-measuring device has broad applicability in industry.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded with the broadest interpretation so as to encompass all such modifications and similar arrangements.

1. A gas concentration measuring device, comprising:
an infrared (IR) gas measuring module for measuring concentration of a gas in the air and producing a concentration signal corresponding to the measured gas concentration;
a circuit processing module for receiving the concentration signal from the IR gas measuring module and converting the concentration signal into an electrical signal, wherein the circuit processing module at least has a linear correcting unit for correcting the electrical signal to form a linearly corrected electrical signal that is in linear relationship with the gas concentration so as to increase the measuring precision and sensitivity; and
a display module for receiving the linearly corrected electrical signal and displaying the gas concentration corresponding to the linearly corrected electrical signal.

2. The gas concentration measuring device of claim 1, wherein the IR gas measuring module includes a controller, a clock generator, an IR sensor, and an IR light source.

3. The gas concentration measuring device of claim 2, wherein the controller provides simultaneous signals to the clock generator and the IR sensor.

4. The gas concentration measuring device of claim 2, wherein the controller is an IR light source controller.

5. The gas concentration measuring device of claim 2, wherein the clock generator generates a square-wave signal to drive the IR light source.

6. The gas concentration measuring device of claim 1, wherein the concentration signal is a small voltage signal.

7. The gas concentration measuring device of claim 1, wherein the circuit processing module includes at least one amplifier circuit, a filter, and a peak sampler.

8. The gas concentration measuring device of claim 1, wherein the display module includes an amplifier circuit.

9. The gas concentration measuring device of claim 1, wherein the display module includes a display device for image displaying and a driver circuit unit for receiving the electrical signal to drive the display device.

10. The gas concentration measuring device of claim 1, wherein the gas is one selected from the group consisting of carbon dioxide, carbon monoxide and hydrocarbon.

11. A gas concentration measuring method, comprising:
measuring concentration of a gas and outputting a concentration signal corresponding to the measured gas concentration via an infrared (IR) gas measuring module;
receiving and processing the concentration signal from the IR gas measuring module via a circuit processing module to form an electrical signal that is in linear relationship with the gas concentration; and
receiving the electrical signal and displaying the gas concentration corresponding to the electrical signal via a display module.

12. The gas concentration measuring method of claim 11, wherein the step of measuring the concentration of the gas includes:
providing simultaneous signals to a clock generator and an IR sensor via a controller of the IR gas measuring module; and
triggering the clock generator via the simultaneous signals from the controller to drive an IR light source of the IR gas measuring module, such that the IR light source emits light beams to the IR sensor so as to allow the IR sensor to measure the IR intensity at a predetermined wavelength and calculate the gas concentration from the IR intensity.

13. The gas concentration measuring method of claim 12, wherein the step of calculating the gas concentration includes simultaneously controlling the clock generator and the IR sensor via the controller, and receiving via the IR sensor a remaining amount of the light beams after being absorbed by the gas.

14. The gas concentration measuring method of claim 11, wherein the concentration signal is a small voltage signal.

15. The gas concentration measuring method of claim 11, wherein the step of processing the concentration signal includes amplifying the concentration signal and filtering out noise therefrom.

16. The gas concentration measuring method of claim 11, wherein the step of processing the concentration signal includes:
performing sampling and calculation according to Beer's Law to obtain an uncorrected electrical signal corresponding to the gas concentration; and
performing linear correction of the uncorrected electrical signal to obtain a linearly corrected electrical signal corresponding to the gas concentration.

17. The gas concentration measuring method of claim 16, further comprising amplifying the linearly corrected electrical signal.

18. The gas concentration measuring method of claim 16, wherein the uncorrected electrical signal and the gas concentration are in exponential relationship with each other, and the linearly corrected electrical signal is proportional to the gas concentration.

19. The gas concentration measuring method of claim 11, wherein the electrical signal is an output voltage.

20. The gas concentration measuring method of claim 11, wherein the gas is one selected from the group consisting of carbon dioxide, carbon monoxide and hydrocarbon.
